(19) United States
(12) Patent Application Publication
(10) Pub. No.: US 2018/0112658 A1
(43) Pub. Date: Apr. 26, 2018

(54) SUBMERSIBLE PUMP ASSEMBLY

(71) Applicant: GRUNDFOS HOLDING A/S, Bjerringbro (DK)

(72) Inventors: Peter FOSMARK, Silkeborg (DK); Flemming MUNK, Viborg (DK); Karsten DYRBYE, Silkeborg (DK)

(21) Appl. No.: 15/661,452

(22) Filed: Jul. 27, 2017

(30) Foreign Application Priority Data
Oct. 25, 2016 (EP) 16195617.2

(51) Int. Cl. F04B 51/00; E21B 47/04; F04B 49/06; G01F 23/24

(52) U.S. Cl. CPC F04B 51/00; E21B 47/042; F04B 17/03; G01F 23/24; F04B 49/06

(57) ABSTRACT

A submersible pump assembly (1), for arrangement in a shaft (2) or receptacle, includes a pump (3) and an electric motor (8) driving the pump (3) and a cable (5) for the supply of electricity. The cable is configured for being led out of the shaft (2) or receptacle at the upper side and for connection to an electricity source (7) outside the shaft or receptacle. The pump assembly (1) includes an electronics unit (9) which is configured to transmit a signal into the cable (5) and to detect a reflection signal at the surface (4) of the fluid (10) located in the shaft (2) or receptacle. The electronics unit (9) is configured to determine, from this reflection signal, a fluid level (11) in the shaft (2) or receptacle by way of time domain reflectometry.

### CROSS REFERENCE TO RELATED APPLICATIONS

This application claims the benefit of priority under 35 U.S.C. § 119 of European Application EP 16195617.2 filed Oct. 25, 2016 the entire contents of which are incorporated herein by reference.

### FIELD OF THE INVENTION

The invention relates to a submersible pump assembly for arrangement in a shaft or receptacle with a pump and with an electric motor driving this, and with a cable for the supply of electricity, the cable being configured for being led out of the shaft or receptacle, at the upper side and for connection to an electricity supply outside the shaft or receptacle. The invention also relates to a method for operating a submersible pump assembly.

### BACKGROUND OF THE INVENTION

Submersible pump assemblies are usually provided with a water-tight, which is to say encapsulated motor, and are applied directly in the water or in a fluid to be delivered, i.e. immersed therein, so that they should be surrounded by the fluid to be pumped at least during operation, due to the fact that a detrimental dry-running of the pump for example could otherwise occur.

For this reason, it is important to continuously detect the fluid level of the fluid surrounding the pump and during operation of the pump, when the submersible pump for example is immersed in a fluid to be pumped. However, it can also be necessary or useful to have knowledge of the fluid level of the fluid surrounding the pump for other reasons.

Amongst other things, it is known from the state of the art, to provide a float switch in the submersible pump, which switches off the drive on reaching a minimum level, in order to avoid a dry running. Moreover, such a float switch can also serve for the regulation which is to say the closed-loop control of the fluid level.

Moreover, it is known from the state of the art, to apply additional sensors and/or additional cables, in order to detect or determine the fluid level of the fluid surrounding the submersible pump, wherein these sensors and cables must be connected to the submersible pump or to the control electronics of the submersible pump.

The solutions which are known from the state of the art however are complicated and are prone to malfunction and therefore cause high manufacturing and maintenance costs.

### SUMMARY OF THE INVENTION

It is therefore an object of the present invention, to provide a submersible pump assembly and a method for operating such a submersible pump assembly, by way of which the fluid level of a fluid, in which the submersible pump assembly is arranged, can be measured in a simple and reliable manner.

According to the invention, a submersible pump assembly is provided for arrangement in a shaft or a receptacle. The submersible pump assembly comprises a pump, an electric motor driving the pump, a cable for a supply of electricity to the electric motor and an electronics unit. The cable is configured for being led out of the shaft or the receptacle, at the upper side and for connection to an electricity supply outside the shaft or the receptacle. The electronics unit is configured to transmit a signal into the cable and to detect a reflection signal at a surface of a fluid located in the shaft or the receptacle, and from the reflection signal to determine a fluid level in the shaft or receptacle by way of time domain reflectometry.

According to another aspect of the invention, a cable is provided for connection to a connection interface of a submersible pump assembly with a pump and with an electric motor driving the pump. The cable comprises a cable structure and an electronics unit integrated into the cable structure or incorporated on the cable structure. The electronics unit is configured to transmit a signal into the cable structure and to detect a reflection signal indicating a surface of a fluid surrounding the cable structure. The electronics unit is configured to determine a fluid level in the environment of the cable by way of time domain reflectometry from the reflection signal. The cable structure comprises an electrically conductive cable comprised of one or more conductive wires with a surrounding insulating sheath/jacket.

According to another aspect of the invention, a method is provided for operating a submersible pump assembly. The method comprises arranging a submersible pump assembly in a shaft or a receptacle. The submersible pump assembly comprises a pump, an electric motor driving the pump, a cable for a supply of electricity to the electric motor, the cable being configured for being led out of the shaft or the receptacle, at the upper side and for connection to an electricity supply outside the shaft or the receptacle and an electronics unit configured to transmit a signal into the cable and to detect a reflection signal indicating a surface of a fluid located in the shaft or the receptacle, and from the reflection signal to determine a fluid level in the shaft or receptacle by way of time domain reflectometry. The method further comprises measuring a fluid level in the shaft or the receptacle, wherein the step of the measuring of the fluid level is carried out with the reflection signal by way of time domain reflectometry.

A submersible pump assembly in the context of the present invention can be any pump which is inserted in a shaft, a receptacle or borehole, thus typically a waste-water pump or a borehole pump. However, it can also the case of a pump for delivering out of a tank or likewise.

The submersible pump assembly according to the invention is envisaged for arrangement in a shaft or receptacle and is provided with a pump and with an electric motor driving this, as well as with a cable for the supply of electricity, said cable being configured for being led out of the shaft or receptacle at the upper side and for connection to an electricity source outside the shaft or receptacle. According to the invention, the pump assembly comprises an electronics unit which is configured to transmit a signal into the cable and to detect a reflection signal at the surface of the fluid located in the shaft or receptacle, and, from this, to determine a fluid level in the shaft or receptacle by way of time domain reflectometry. According to the configuration according to the invention, one succeeds in the water level of the fluid in the shaft or receptacle, in which the submersible pump assembly is arranged, being able to be reliably detected in a simple and inexpensive manner. No additional sensors or float switches are necessary for this, since the measurement is carried out via the electricity cable which is present in any case.

Not only do the pump and the electric motor driving this belong to the submersible pump assembly in the context of the invention according to the application, but also an electronics unit arranged in or on the assembly casing, as well as a cable for the supply of electricity.

The leading-out of the cable at the upper side, in the context of the present invention is not necessarily to be understood as the leading-out of the cable at the upper side of the shaft, but in contrast this can also be effected laterally, transversely to the shaft wall and offset thereto, but usefully above the maximally expected fluid level of the shaft or receptacle.

A basic concept of the invention its therefore to largely make do without sensor devices for detecting the fluid level in the shaft or receptacle, and, by way of a suitable upgrade of the electronics unit which as a rule is present in any case, to feed a signal into the supply cable which is likewise present in any case, in order to detect a reflection signal arising at the surface of the fluid located in the shaft or receptacle, and from this signal, to determine the current fluid level by way of time domain reflectometry. The particular advantage of the solution according to the invention also lies in the fact that this as a rule can be provided on common submersible pump assemblies without having to change these with regard to their design, and that a suitable design changes only needs to be made on the part of the electronics unit.

According to the invention, the electronics unit which is provided for producing the signal and receiving the reflection signal and is thus envisaged for determining the fluid level can be arranged within a casing accommodating the pump and the drive motor, but also at the outside, on or in the proximity of this casing. Thus, for example, a cable interface can be provided close to this casing or on the casing, onto which cable interface the actual cable leading out of the shaft and with the associated electronics unit is then arranged. Such an interface with regard to the design is to be formed such that on the one hand the interface is arranged as closely as possible to the casing receiving the pump and the electric motor, and on the other hand the necessary sealedness for application within a fluid is ensured, as the case may be at a depth of several hundred meters.

According to a preferred embodiment of the invention, the cable is a standard electricity cable, in particular of copper—copper wire with a surrounding insulating sheath/jacket. This is a particularly inexpensive variant, since the cables do not need to be designed in any special way or manner, so as to function as sensors, but merely need to provide a working current for operating the electric motor of the submersible pump. The signal incoupling and outcoupling can be effected capacitively.

With the use of a standard electricity cable (power cable), the signal must be coupled into this and the received reflection signal must be coupled out of this. Any communication signals, for example between an external motor control, i.e. one arranged outside the shaft, and the electronics unit are likewise to be led via this cable, for example by way of a powerline communication which is known per se and which is known from the field of network technology. A variant, with which at least one separate conductor is provided in the cable next to the current conductors, and on the one hand is provided for the signals and reflection signals necessary for time domain reflectometry and on the other hand is preferably also used for data communication with an external motor control, is simpler and less prone to malfunctioning than the configuration with the current, data, and the signals and reflection signals being passed through the same conductors. The signals which are necessary for measurement of the fluid level are then completely independent of the current subjection and harmonics/interference signals which this typically entails. The data communication can also be effected in a significantly simpler and more stable manner by way of such a separate conductor, be it by way of suitable modulation of the signals or preferably by way of the temporal separation of the measurement signal and communication signal.

According to a further preferred embodiment, at least one marker, preferably a metallic ring is arranged on the cable. A marker in the context of the invention according to the application can be any suitable formation on the cable, which is suitable for changing the capacitive characteristics in this region of the cable and thus for producing a reflection signal. This, for example, can be effected by way of a thickening in the insulation (sheath/jacket), the integration of a metal section or however preferably by way of the arrangement of a metallic ring on the cable. One or more further markers or metallic rings can be arranged on the cable at a predefined distance to the marker or metallic ring and/or the pump assembly. The arrangement of one or more markers, in particular metallic rings on the cable has the effect that the dielectric field in the inside of the cable changes and thus an even more accurate measurement is rendered possible. Not only can a reflection signal be obtained from the surface of the fluid with the help of these markers/metallic rings, but also a reflection signal of these markers/rings, by which means the measuring accuracy can be increased and a calibration becomes possible. The marker or markers/ring or rings is/are arranged at a predefined distance (to one another and to the pump assembly) for this purpose. Such metallic rings can be mechanically fastened on the cable at the outside of the cable in a simple manner, or also be integrated in the sheath/jacket of the cable in the case of the use of a special cable.

It is particularly advantageous if the signal transmitted by the electronics unit into the cable is a coded pulse sequence. A noise which is caused by a frequency converter or other devices creating noise can be suppressed or compensated by way of this.

The cable preferably consists of a first cable section connected to the pump assembly and of a second cable section which is to be connected to the electricity source (power source), wherein the first cable section and the second cable section are connected to one another at a connection interface by way of a connection element. Such an arrangement has the advantage that the pump assembly with the connection cable can always be designed in the same manner, independently of the necessary cable length, and it is only the second cable section leading from the connection interface to the electric connection which needs to be manufactured specific to length.

According to an advantageous further development of the invention, the pump assembly, in particular the electronics unit comprises means for detecting a dry running of the pump, said means being formed in the electronics unit and using the data determined by time domain reflectometry. The dry running can be ascertained for example on falling short of a minimum fluid level, at which an automatic switch-off is then preferably effected. For this, it is therefore not necessary to detect the actual running-dry of the pump. It is also possible to combine time domain reflectometry with a conventional dry running detection, e.g. detection by way of motor current monitoring. According to a further development of the invention, the penetration of fluid into the connection element or cable can also alternatively or additionally be determined by way of the electronics unit, since the capacitive behavior of the components to one another changes due to this, and this can be determined by way of a suitable design of the electronics unit. Thereby, the connection interface can lie on a short cable section in the proximity of the pump casing or however also directly on the pump casing, and the first cable section then lies exclusively within the casing.

It is also advantageous if the pump assembly further comprises means for determining a dielectric change at the connection interface of the first and second cable section and/or means for compensating the dielectric change at the connection interface of the first and second cable section. This interface can consequently be monitored in a simple manner by way of a suitable design of the electronic construction unit, and any resulting changes, e.g. of the contact resistance, can be taken into account or compensated with regard to the measurements.

The electronics unit preferably lies within the casing receiving the pump and the electric motor, but can also be arranged on the outer side of this casing in a separate casing. The latter particularly lends itself for retrofitting existing pump designs, without having to change the basic construction.

If in contrast a pump assembly is to be brought onto the market, selectively with or without such an electronics units, for example a simple inexpensive variant without a fluid level sensor, and a more expensive one with a fluid sensor according to the present invention, it can then be advantageous to integrate the electronics unit into the second cable section, preferably into the connection element itself, in order, where possible, to be able to use the complete cable located within the shaft/fluid, up to the pump, for determining the fluid level, or however in the region of the first meter of the end of the cable section which is at the connection interface side. Thus, one and the same pump can be configured as described above, merely by way of the selection of the second cable section, in the case of such a design.

A cable end filter is advantageously provided at least at one end of the cable which is to be connected electricity source. Such a filter, which is typically a low-pass filter, holds back the high-frequency harmonics on the part of the electricity source, particularly with the application of a frequency converter, but also holds back interference signals of the motor/motor electronics. The end of the cable can also be determined by way of the cable end filter, by way of time domain reflectometry. Such a filter is preferably not only provided at the end of the cable which is at the electricity source side, but also at the motor-side end of the cable, and specifically in front of the electronics unit, in order to also eliminate harmonics/interference on the part of the motor. These filters are to be matched or adapted with regard to the measurement signals as well with regard to the communication signals, in the case that communication data is likewise transmitted via the current-leading conductors. The communication signals are advantageously fed into the cable and received out of the cable, by way of a communication unit forming part of the electronics unit.

A calibration of the measuring device is usefully not only to be carried out before the first measurement, but wherever possible at regular intervals, since the cable located in the fluid can change over the course of time due to external influences, of example due to the accumulation of algae or small fauna. The calibration is thereby effected with the help of the markers attached on the cable, the distance of which markers to the pump being known, and these markers produce a detectable reflection signal irrespective of the surrounding medium. The determined values are thereby usefully stored, so that a comparison with the values of the prior calibrations is possible, and hence long-term changes due to external influences can be determined and taken into account. According to an advantageous further development of this method, the penetration of fluid into the cable or into a connection element of a connection interface of the cable can also be determined with this, and for this, a microprocessor as well as a memory are usefully present in the electronics unit, and this microprocessor detects these conditions on account of the previously determined characteristic values by way of implemented software and, as the case may be, signals this via the communication unit or activates an alarm.

A frequency converter and the motor control can moreover be provided between the cable end filter and the electricity source.

Moreover, according to the invention, a method for operating a submersible pump assembly is provided, wherein the method comprises a step of measuring the fluid level in a shaft or receptacle, in which the pump assembly is arranged, wherein the step of measuring the fluid level is carried out by time domain reflectometry.

The step of the measuring the fluid level preferably comprises a transmitting of a signal, in particular a signal with a pulse sequence with an amplitude of 5V, into an electricity cable connecting the pump assembly to an electricity source, and a detecting of a change of the transmitted signal at the surface of the fluid in the receptacle, in particular at the liquid-air boundary.

Moreover, according to a preferred embodiment example, an electronics unit provided in the pump assembly can send the signal to the cable and measure the time which is required until a change of the amplitude of the signal in the cable occurs, and compute the length of the cable from the pump assembly up to the liquid-air boundary from the measured time.

It is advantageous if the step of measuring is carried out during a standstill of the pump, during starting operation for the first time or during the operation of the pump. Electrical noise which is caused by the electric motor ad/or the frequency converter on operation of the pump is advantageously avoided and hence cannot influence the measurement signal, if the step of measuring is carried out when the pump is stopped which is to say is not in operation.

The method can further comprise a step of detecting a dry running of the pump. The detecting of the dry running of the pump can either be effected on falling short of a predefined minimum fluid level or however in the case that the reflection signal to be measured cannot be determined at all. The latter design protects the submersible pump assembly from non-defined conditions or in the case of part-defects of the electronics unit.

With waste-water pumps, with which the pump assembly is arranged standing on the ground or fluid bed and it is a question of pumping away the fluid, where possible down to the fluid bed, thus of not switching off the pump until just before a possible dry running, it is useful to lead the cable typically exiting at the upper side of the assembly casing, laterally on the casing close to the standing surface, in order to then direct it upwards by 180. A very accurate evaluation of the fluid level, also in the region of the height of the pump can be effected with such a leading of the cable, given a suitable arrangement of the previously mentioned markers and suitable calibration. In such a case, an air-liquid boundary is then to be detected instead of a probably more frequently occurring liquid-air boundary. The cable e.g. is fixed on the pump assembly with an annular strap or band, or with a metal or plastic ring, which encompasses the cable and the pump casing.

With regard to the leading of the cable, it is occasionally necessary not to lead the cable upwards directly from the pump assembly, but firstly as the start to lead it transversely, i.e. horizontally or obliquely to this. The horizontal part of the cable must of course not be included in the computation when determining the fluid level. This is advantageously effected automatically by the electronics unit by way of implementation into the software, if specifically it is ascertained within the electronics unit that the fluid level drops ad hoc to zero from a predefined value. This can be recognized with a one-off occurrence or if it occurs several times and then accordingly be taken into account with subsequent measurements. It is also conceivable for the electronics unit to be programmable via the cable itself, by way of a communication interface, so that the service technician on location, when installing the pump assembly, can already input this and can take this into account in the electronics unit on signal evaluation. This region can alternatively or additionally also be defined by a marker provided on the cable, for example by way of two rings or other suitable markers, which are successively arranged at a small distance.

The invention is hereinafter explained in more detail by way of an embodiment example represented in the drawing. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a greatly simplified schematic representation of a submersible pump assembly according to the invention, in a fluid filled shaft, wherein the shaft is represented in section;

FIG. 2A is a measurement diagram produced with the method according to the invention at different filling levels in the shaft, within the submersible pump assembly and is to be evaluated;

FIG. 2B is another measurement diagram produced with the method according to the invention at different filling levels in the shaft, within the submersible pump assembly and is to be evaluated;

FIG. 2C is another measurement diagram produced with the method according to the invention at different filling levels in the shaft, within the submersible pump assembly and is to be evaluated;

FIG. 2D is another measurement diagram produced with the method according to the invention at different filling levels in the shaft, within the submersible pump assembly and is to be evaluated;

FIG. 3 is a representation of an alternative design of a submersible pump assembly according to FIG. 1;

FIG. 4 is a schematic longitudinal sectioned representation, a borehole pump according to the invention; and

FIG. 5 is a block diagram of one embodiment variant of the invention.

### DESCRIPTION OF THE PREFERRED EMBODIMENTS

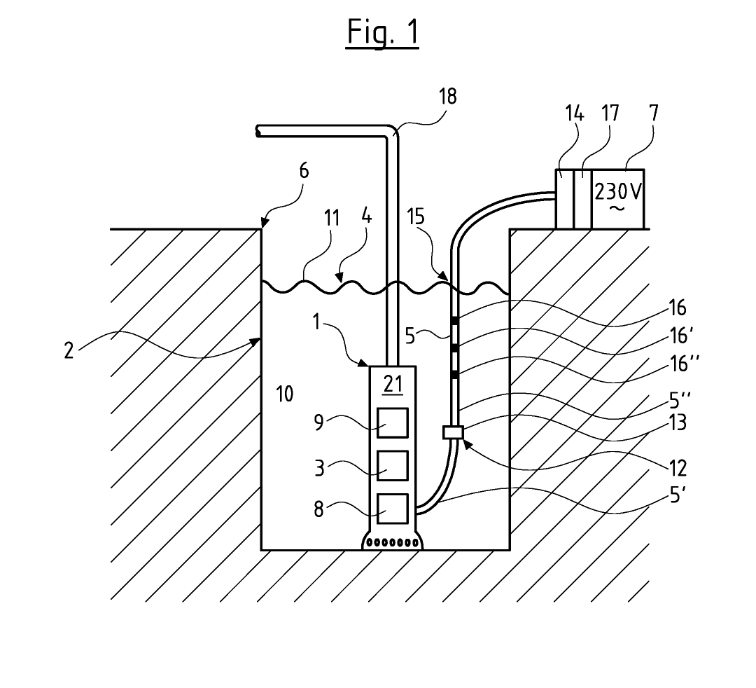

Referring to the drawings, not only is a shaft 2 represented in section in FIG. 1, but also a submersible pump assembly 1 which is located in this. The shaft 2 is filled with a fluid, here water 10, and has a fluid level 11. The submersible pump assembly 1 which here is completely surrounded by the water 10, comprises a pump 3 and an electric motor 8 driving the pump 3. The electric motor 8 is connected via a cable 5, namely a cable structure with copper wire and a surrounding sheath/jacket, to an electricity source 7 arranged outside the shaft 2.

The cable 5 comprises a cable a first cable section 5′ and a second cable section 5″ which are connected to one another at a connection interface 12 by way of a connection element 13, and can have a total length of up to several hundred meters. Thereby, the first cable section 5′ which is fixedly connected to the pump assembly 1 in a direct manner is typically provided by the manufacturer in a manner connected to the pump assembly 1. The second cable section 5″ is provided in a customized manner, thus is manufactured according to the required length. As can be recognized in the figure, here, by way of example, three metallic rings 16, 16′, 16″ are arranged on the cable 5 at a predefined distance to one another. The rings 16, 16′ 16″ change the dielectric field in the cable 5 and form markers which permit a more precise measurement of the fluid level.

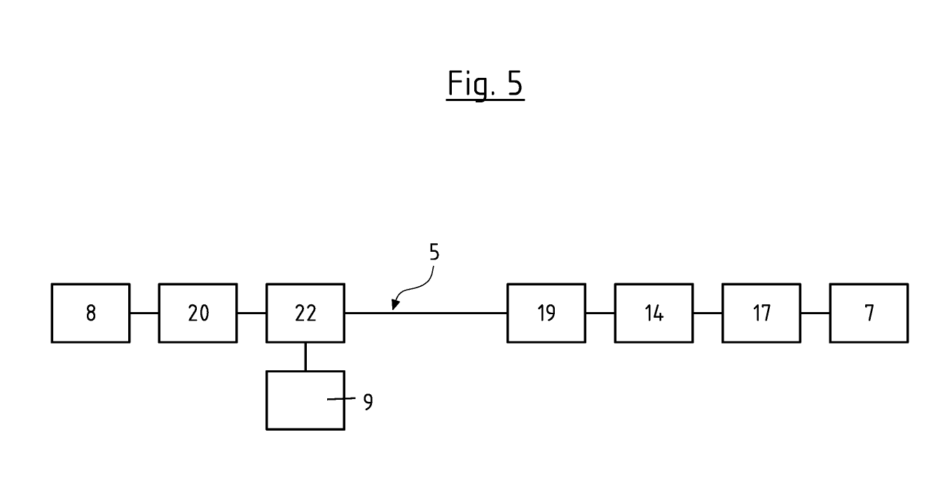

The cable 5 is led out of the shaft 2 at the upper side 6 of this, and is thus connected to the electricity source 7 outside the shaft 2, which is to say via a cable end filter 19 provided at the electricity source 7 and represented in FIG. 5. A frequency converter 14 as well as a motor control 17 is moreover arranged between the cable end filter 19 and the electricity source 7.

A delivery conduit of the pump assembly 1 is indicated at 18, through which conduit the fluid delivered out of the shaft 2 by the pump 3 is led away.

The pump assembly 1 moreover comprises an electronics unit 9. This electronics unit 9 is configured also for detecting a dry-running of the pump 3, and for this uses the data determined by time domain reflectometry, as well as for determining a dielectric change at the connection interface 12 of the first and second cable section 5′, 5″ and for compensating the dielectric change at the connection interface of the first and second cable section. The electronics unit 9 is thus configured so as to feed a signal into the cable 5 and to detect a reflection signal at the surface 4 of the water 10 located in the shaft 2, and from this to determine a fluid level 11 or the filling level 11 in the shaft 2, by way of time domain reflectometry, as is described in detail hereinafter.

The electronics unit 9 sends a signal into the copper wire of the cable 5 which is to say into the first and second cable section 5, 5″, during a standstill of the pump 3 or before or during first starting operation of the pump 3, i.e. whilst the frequency converter 14 is inactive and provides no electricity or current to the electrical motor 8 for driving the pump 3. The signal for example is a pulse sequence with amplitude of 5 V. The electronics unit 9 then measures the time until a change of the amplitude of the signal occurs (the change contained in the detected reflection signal). This change occurs exactly at the location 15 where the cable 5 exits out of the water 10 and is then surrounded by air. The dielectric parameters in the inside of the cable 5 change at precisely this point 15, specifically at the transition water-air, on account of a change in the capacitive leakage of water to air, which in turn effects an increase of the signal amplitude on the cable. The length of the cable up to the electronics unit 9 or the motor 8 can be computed from the information as to when this change is the amplitude has occurred, i.e. from the temporal interval between sending the signal and the occurrence of the change contained in the detected reflection signal, and this length corresponds essentially to the fluid level 11 in the shaft 2. The fluid, here the water 10, has a dielectric constant which is significantly larger than that of the air above the shaft 2 filled with water 10.

Instead of carrying out the measurement described above during a standstill of the pump 3, it can also however be carried out when the pump 3 is operated, i.e. activated via the frequency converter 14. The measurement signal for determining the fluid level and which is sent by the electronics unit 9 or fed into the cable 5 is then a coded signal and typically has a frequency in the megahertz range. The noise which is caused by the frequency converter 14 or other devices or the electric motor 8 itself are suppressed due to coding the signal.

As the block diagram according to FIG. 5 illustrates, the electronics unit 9 is not arranged in series, but parallel to the electricity supply, between the electricity source 7 and the electric motor 8, and specifically via a coupling member 22. The coupling is effected via a Y-capacitor 22 with a capacitance of 4.7 nF. Not only is the coupling of the measurement signals, i.e. emitting of a pulse sequence and the receiving of one or more reflection signals effected via this, but also the data transfer, i.e. the transmission of the filling level 11 determined in the electronics unit 9 to the control 17 of the electric motor 8. The incoupling and outcoupling of the measurement signals as well as that of the data communication is thereby effected into a current-leading conductor of the cable 5 supplying the pump assembly with electricity. The data communication between the electronics unit 9 and the control 17 is effected via a CAN-bus, but can also be carried out via other communications protocols. A filter 20 is arranged between the electric motor 8 and the coupling member 22, so as to filter out the interference signals originating from the electric motor 8. The cable end filter 19 which filters interference signals possibly coming from the mains or from the frequency converter 14 is arranged at the other end.

A separate conductor can alternatively be provided in the cable 5 and this is envisaged exclusively for coupling in and coupling out the measurement signals as well as for data communication. A direct coupling-in can then be effected and the noise filters 19, 20 can then be largely done away with. For this, the electronics comprise a communication unit which is not represented in the figures.

The electric motor 8 can be stopped during the measurement, i.e. the pump 9 is switched to being drive-free, in order to further improve the quality of the measured signal and thus the measurement as a whole. Here, electric noise which is caused by the electric motor 8 is avoided by this, so that the measured signal, i.e. the refection signal is not compromised due to this.

Thereby, not only is the filling level 11 in the shaft 2 detected by way of the electronics unit 9, but the electronics unit 9 is moreover also configured to switch off the pump 3, i.e. the electric motor 8, if the detected fluid level falls short of a minimal value corresponding roughly to the construction height of the pump assembly 1 or if a fluid level cannot be determined at all, in order to prevent a dry running of the pump in this manner. One can completely make do without separate dry-running sensor on account of this.

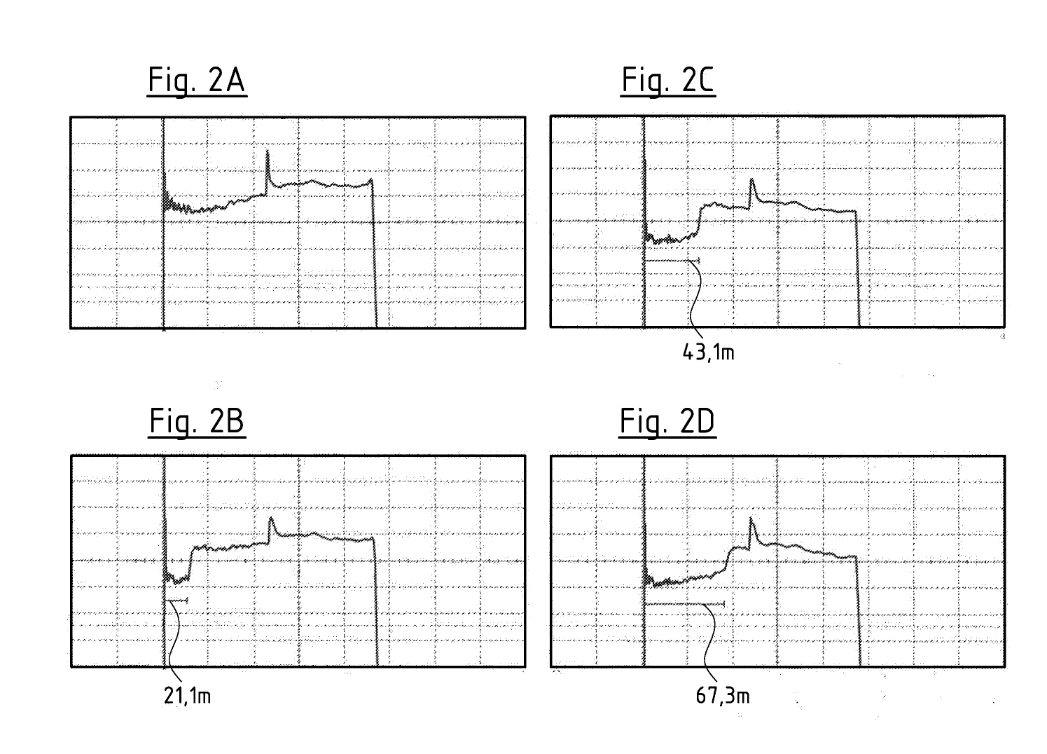

Diagrams of measurement results at different filling levels, such as at a fluid level 11 as is represented in FIG. 1, and which were determined by way of the method described above, are represented in FIG. 2A to 2D.

Tests were carried out, firstly in a 70 m deep shaft, for example in the shaft 2 represented in FIG. 1, wherein a 150 m long electricity cable was used, as is normally applied in such shaft applications. The excess cable length thereby runs along the ground surface outside the shaft. Hereby, a 3% signal stage was measured at the position where the transition from water to air or vice versa from air to water is located. The measured signal stage gradient reduces with the distance of the fluid level 11 to the pump assembly 1. The signal stage gradient dV/dt should therefore be kept as large as possible, i.e. as steep as possible. In the embodiment example, dV/dt for example is smaller than or equal to 1 V per nanosecond. A lower fluid level 11 can be determined in a very reliable and precise manner, since the water level measurement is carried out relative to the pump assembly 1. The measuring errors increase with an increasing fluid level 11, in the case that the electricity cable is not adequately defined. There exists the possibility of assembling markers on the electricity cable as height indicators, which for example can be realized by hard-foam or tightly seated metal sleeves 16, 16′, 16″, in order to reduce the measuring errors, in particular at high water levels.

The measurement results or readings which in each case represent the signal amplitude (voltage) over time and which are represented in FIGS. 2A, 2B, 2C and 2D, arose from an arrangement, with which TDR (time domain reflectometry) measuring electronics are arranged or assembled in the inside of the pump 3 (see FIG. 1). As can be recognized here, a measurement which was carried out at a fluid level of 0 m above the pump is represented in FIG. 2A. In contrast, FIG. 2B relates to a measurement at a fluid level of 21.1 m of water above the pump, FIG. 2C relates to a measurement at a fluid level of 43.1 m of water above the pump and FIG. 2D relates to a measurement at a fluid level of 67.3 m of water above the pump 3. As can be recognized in FIG. 2B to 2D, a sudden increase of the measurement curve can be recognized at the transition water-air, from which increase one can then deduce the height of the water column or of the fluid level.

The configuration according to the invention, for determining the fluid level 11 in a shaft 2 or container, in which a submersible pump assembly 1 is arranged, as a whole permits many further advantages additionally to those which have already been mentioned. For example, a significant robustness with regard to external influences results. Tolerances can be adapted in accordance with the demands, by way of the provision of reference reflectors/markers at known positions and/or by way of the provision of suitable information concerning the cable type. On the other hand, changes to the system, for example the penetration of fluid into a connection element 13 or into the cable 15, deposits on the cable 5, damage to the cable 5 and a dry-running of the pump can be determined with the help of markers 16 and regularly effected calibration procedures. The signal-to-noise ratio can be improved if the current is switched off for very short time periods, in particular so short that it does not even compromise the electric motor. The varying speed of the electrical impulse can be preset if the cables are known.

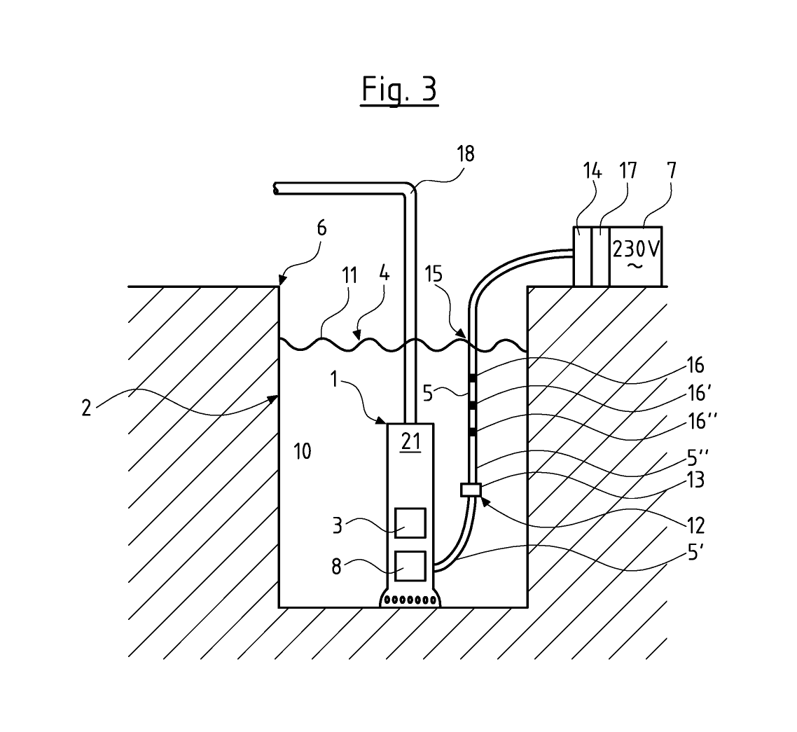

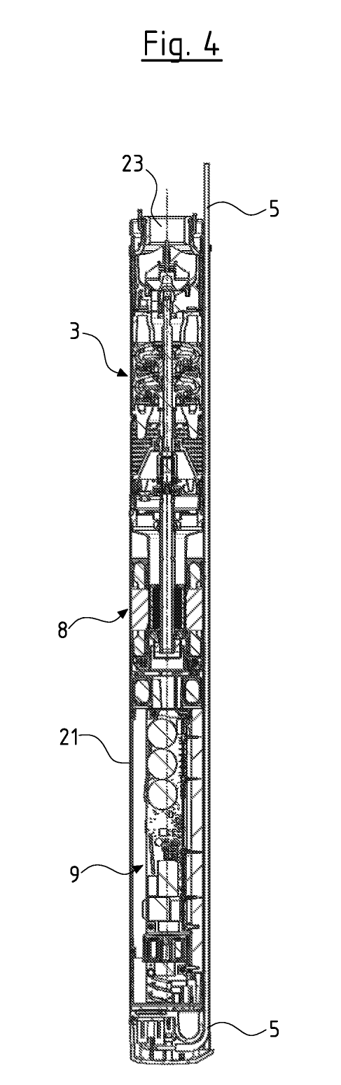

With regard to the pump assembly 1 represented by way of FIG. 1, the electric motor 8, the pump 3 and the electronics unit 9 are arranged in a common casing 21, out of which the cable exits close to the ground-side placement surface. Such a configuration, as is represented in detail by way of FIG. 4 for borehole pump, as a rule is to be preferred with new designs. The embodiment variant represented by way of FIG. 3 differs from this, wherein with regard to this embodiment, only the pump 3 and the electric motor 8, as well as parts of the motor electronics which are located there as the case may be, are arranged within the assembly casing 21, but the electronics unit 9 is arranged on the outer side of the casing in a separate casing. Such an arrangement lends itself when retrofitting existing designs with little effort with regard to the fluid level measurement. Finally, as already discussed earlier, the electronics unit 9 can also be arranged within a casing (not shown in the drawings), which forms part of the connection element 13 or of the second cable section 5″. The submersible pump assembly can then be configured selectively with or without sensorics, depending on the selection of the cable.

With the borehole pump represented by way of FIG. 4, the electric motor 8, the pump 3 and the electronics unit 9 are arranged in a cylindrical casing 21, and the electronics unit 9 is thereby part of the motor electronics located therein. The cable 5 is led out at the lower side of the casing 21 and is led upwards, bearing on the casing 21 and laterally of this casing 21. The electric motor 8 driving the here two-stage centrifugal pump 3 arranged thereabove, connects to the electronics unit 9 to the top, within the casing 21. The sucking of the fluid is effected through recesses in the cylinder wall of the casing 21, in the region between the motor 8 and the pump 3, and the exit via an exit branch 23 on the upper side of the casing 21, on which branch the delivery conduit connects. With this pump, it is useful to provide a first marker (16″) on the cable 5, above the pump casing 21, and this marker (16″) represents the minimal filling level, on falling short of which a dry-running is ascertained and the pump assembly is switched off. Further markers (16, 16′, 16″) are usefully attached at a significant distance, in order to increase the accuracy of the fluid level detail with an increasing distance to the pump.

A calibration of the measuring device can be effected for example with the help of the three markers in the form of metal rings indicated at 16, 16′ and 16′, wherein these are attached on the outer side of the cable 5. The distance of these rings to one another and to the pump has been measured beforehand, so that reflection signals are obtained from the rings 16, 16′ and 16″ at temporal intervals on coupling a measurement signal in the form of a pulse sequence, into the cable 5. The travel times which are measured in this context are then correlated with previously measured lengths, whereupon the travel time of a reflection signal at the fluid surface 11 can be accordingly determined. A suitable number of markers are to be provided on the cable at suitable distances, in order to achieve an accurate measurement, where possible over the whole cable length.

While specific embodiments of the invention have been shown and described in detail to illustrate the application of the principles of the invention, it will be understood that the invention may be embodied otherwise without departing from such principles.

### APPENDIX

### List of Reference Numerals

1 submersible pump assembly
2 shaft
3 pump
4 water surface
5 cable (5′ first cable section/5″ second cable section)
6 upper side of shaft
7 electricity source
8 electric motor
9 electronics unit
10 water
11 filling level/fluid level
12 connection interface
13 connection element
14 frequency converter
15 location
16, 16′, 16″ rings
17 motor control
18 delivery conduit
19 filter
20 filter
21 casing
22 coupling member
23 exit branch

What is claimed is:

1. A submersible pump assembly for arrangement in a shaft or a receptacle, the submersible pump assembly comprising:
a pump;
an electric motor driving the pump;
a cable for a supply of electricity to the electric motor, the cable being configured for being led out of the shaft or the receptacle, at the upper side and for connection to an electricity supply outside the shaft or the receptacle; and
an electronics unit configured to transmit a signal into the cable and to detect a reflection signal at a surface of a fluid located in the shaft or the receptacle, and from the reflection signal to determine a fluid level in the shaft or receptacle by way of time domain reflectometry.

2. A pump assembly according to claim 1, wherein the cable is a standard electricity cable comprised of copper, and a signal incoupling and a signal outcoupling is effected capacitively via a Y-capacitor.

3. A pump assembly according to claim 1, wherein the cable comprises at least one current conductor and at least one separate conductor for the transmitted signals and reflection signals for the time domain reflectometry and the at least one separate conductor also forms a motor data communication line with an external motor control.

4. A pump assembly according to claim 1, further comprising at least one marker comprising a metallic ring, which can be detected by way of time domain reflectometry, is arranged on the cable.

5. A pump assembly according to claim 4, further comprising at least one further marker arranged on the cable at a predefined distance to the at least one marker.

6. A pump assembly according to claim 1, wherein the signal which is transmitted by the electronics unit into the cable is a coded pulse sequence.

7. A pump assembly according to claim 1, further comprising a connection element wherein the cable comprises a first cable section, which is connected to the pump assembly, and a second cable section, which is to be connected to the electricity source, wherein the first cable section and the second cable section are connected to one another at a connection interface by way of the connection element.

8. A pump assembly according to claim 7, wherein the pump assembly comprises detecting means for detecting a dry running of the pump or detecting a penetration of fluid into the connection element or detecting a dry running of the pump and detecting a penetration of fluid into the connection element, said detecting means being formed in the electronics unit and using data determined by way of time domain reflectometry.

9. A pump assembly according claim 1, further comprising a casing receiving the pump and the electric motor, wherein the electronics unit is arranged within the casing or on an outer side of the casing.

10. A pump assembly according to claim 7, wherein the electronics unit forms part of the second cable section and is integrated in a first meter of an end of the second cable section, which second cable section is at a connection interface side, or in the connection element.

11. A pump assembly according to claim 7, wherein the electronics unit further comprises dielectric change determining means for determining a dielectric change at the connection interface of the first and second cable section or dielectric change compensating means for compensating the dielectric change at the connection interface of the first and second cable section.

12. A pump assembly according to claim 1, further comprising:
a cable end filter at an end of the cable which is to be connected to the electricity source; and
a frequency converter or a motor control or a frequency converter and a motor control provided between the cable end filter and the electricity source.

13. A pump assembly according to claim 1, wherein the electronics unit comprises a communication unit, via which communication signals are fed into the cable and are received out of the cable.

14. A cable for connection to a connection interface of a submersible pump assembly with a pump and with an electric motor driving the pump and, the cable comprising:
a cable structure; and
an electronics unit integrated into the cable structure or incorporated on the cable structure, the electronics unit being configured to transmit a signal into the cable structure and to detect a reflection signal at a surface of a fluid surrounding the cable structure and, from this, to determine a fluid level in the environment of the cable by way of time domain reflectometry.

15. A method for operating a submersible pump assembly the method comprising the steps of:
arranging a submersible pump assembly in a shaft or a receptacle, the submersible pump assembly comprising a pump, an electric motor driving the pump, a cable for a supply of electricity to the electric motor, the cable being configured for being led out of the shaft or the receptacle, at the upper side and for connection to an electricity supply outside the shaft or the receptacle and an electronics unit configured to transmit a signal into the cable and to detect a reflection signal at a surface of a fluid located in the shaft or the receptacle, and from the reflection signal to determine a fluid level in the shaft or receptacle by way of time domain reflectometry; and
measuring a fluid level in the shaft or the receptacle, wherein the step of the measuring of the fluid level is carried out by way of time domain reflectometry.

16. A method according to claim 15, wherein the step of measuring the fluid level comprises a transmitting of a signal with an amplitude of 5 V, into the electricity cable connecting the pump assembly to an electricity source, and a detecting of a change of the transmitted signal at a liquid-air boundary of the fluid in the receptacle.

17. A method according to claim 16, wherein the electronics unit sends the signal onto the cable and measures a time which is required until a change of amplitude of the signal in the cable occurs and computes a length of the cable from the pump assembly up to the liquid-air boundary from the measured time.

18. A method according to claim 15, wherein the step of the measuring is carried out during a standstill of the pump, during first starting operation of the pump or during operation of the pump.

19. A method according to claim 15, wherein a calibration is effected on the basis of markers which are attached on the cable and of a known position of the markers along the cable, and the calibration is repeated automatically in temporal intervals, wherein determined values are stored in the electronic unit and are used with subsequent evaluations of fluid levels.

20. A method according to claim 19, wherein the determined values, which are determined with successive calibration procedures, are compared, and a penetration of fluid into the cable or into a connection element of a connection interface of the cable is determined by way of the comparison.

21. A method according to claim 15, further comprising detecting a dry running of the pump when the determined fluid level reaches or falls short of a predefined value.
